(19) United States
(12) Patent Application Publication
(10) Pub. No.: US 2015/0251931 A1
(43) Pub. Date: Sep. 10, 2015

(54) Fracking Waste Water Recycling to Purified Steam for Energy Recovery

(71) Applicant: Stephen Grot, Newark, DE (US)

(72) Inventor: Stephen Grot, Newark, DE (US)

(73) Assignee: Ion Power, Inc., New Castle, DE (US)

(21) Appl. No.: 14/640,623

(22) Filed: Mar. 6, 2015

Related U.S. Application Data
(60) Provisional application No. 61/949,873, filed on Mar. 7, 2014.

(51) Int. Cl. C02F 1/44; B01D 67/00; B01D 71/36; B01D 61/36

(52) U.S. Cl. CPC C02F 1/448; B01D 61/366; B01D 61/362; B01D 67/0088; B01D 71/36; C02F 2103/10

(57) ABSTRACT

A method of recovering waste water from hydrocarbon production wells includes filtering contaminated water directly from a production site and filtering through a perfluorosulfonic acid containing membrane to produce purified steam while losing only about 1 atmosphere of pressure. The steam can be used for energy recovery or condensed and recycled into a subsequent production site.

### SUMMARY OF THE INVENTION

During petroleum and gas production, large volumes of highly contaminated waste water are recovered. Reuse of these waters, including recycling these waters to generate purified steam, is highly desired. However, prior to reuse, the recovered, contaminated water must be treated. Current practices of waste water treatment and/or producing high quality steam from recovered, contaminated water are complex, highly inefficient, unreliable, and come at a major cost. For example, before generating purified steam from Steam Assisted Gravity Drainage (SAGD) and hydraulic fracturing (“fracking”), current practices require cooling the recovered, contaminated water an initial time to remove the majority of oil, and then further cooling and treating the remaining water to remove additional secondary oil. After oil removal, the resulting water then has to undergo additional multi-step processing to be demineralized before being re-heated to produce purified steam. The use of evaporator/drum boiler systems, for example, has been suggested to make the above process more efficient. However, these systems continue to have large operating costs and have not yet been proven to be a better approach.

The current disclosure addresses the drawbacks of the previous practices by providing a perfluorosulfonic acid containing membrane that allows only purified water, with no or very low contaminants, to be transported from the oil/water mix coming from the formation at 200° C., 20 bar. By “low contaminants” as used herein, is meant contaminants at levels of less than 8000 parts per million dissolved solids and less than 1 part per million dissolved oil and grease, for example. A preferred perfluorosulfonic acid membrane is commercially marketed under the trade name NAFION™ by Dupont™. The purified water transported through the membrane can be delivered as steam or as liquid water depending on the temperature/pressure operating conditions of the membrane system. In one embodiment, the perfluorosulfonic acid containing membrane acts as a high temperature Reverse Osmosis (“RO”) membrane where the membrane simply allows purified water through directly from the 200° C., 20 bar oil/water mixtures from the well. The hot purified water that passes through the membrane can be directly fed to a Once-Through Steam Generator (OTSG) boiler at essentially 200° C., 19 bar. Because the oil/water mix typically contains relatively low total hardness of only 30 ppm as CaCO₃, a large portion of water from an oil/water mix from a well can be transported across the membrane without membrane fouling issues, and directly recycled into an OTSG boiler without any further water treatment. Since the temperature/pressure characteristics of the oil/water mix are unchanged by flowing through the RO system, more purified water can be extracted from the oil/water mix in the form of purified steam.

In another embodiment, the same type of newly developed membrane can also be used to generate high purity steam directly from an oil/water mix coming from a well. Due to the high heat of vaporization of water, it is estimated that only 10% of the oil/water mix can be converted to steam before the temperature of the water has cooled to 150° C. The current disclosure offers certain advantages over the prior art by involving fewer steps, being more energy efficient, keeping the temperature of the water as high as possible at all times, being more reliable, and reducing costs.

NAFION™ has an extremely high water transport rate and excellent selectivity against many organics. It is estimated that a 50 micron thick NAFION™ membrane can transport between 20 kg (see P. W. Majsztrik et al., “Water sorption, desorption and transport in Nafion membranes,” Journal of Membrane Science 301 (2007) 93-106) and 100 kg (see Q. Duan et al., “Transport of liquid water through Nafion membranes,” Journal of Membrane Science 392-393 (2012) 88-94) of water/m² of membrane/min at 200° C. and a 1 bar pressure delta. Thus, in order to transport 7300 liter /min of water, for example, only 73-360 m² of membrane is required.

The membrane preferably has NAFION™ coated on a temperature resistant substrate that is cost effective and has small pores of 10 microns or less. The substrate can include, but is not limited to, glass fiber reinforcement. A Carbon black/poyltetrafluoroethethylene (TEFLON™) mix can be used to make a microporous supporting structure. The supporting structure can then be coated with a perfluorosulfonic acid such as NAFION™ or a modified NAFION™ dispersion so that the membrane is gas tight. Alternatively, an acid base stable nanofiltration membrane such as the Koch SelRo™ MPF-34 sheet material (Koch Membrane Systems, Inc., Wilmington, Mass.) that has a nanoporous silicone coating can be used and coated with a perfluorosulfonic acid layer for the water selectivity. In another embodiment, the Silica Solgel approach can be used to bind a perfluorosulfonic acid with Silica and that mixture can be incorporated into an appropriate membrane supporting structure. The NAFION™ can also be cross-linked or a high equivalent weight version of the polymer can be used that has much less swelling behavior.

The perfluorosulfonic acid containing membrane is preferably built in a plate/frame heat-exchanger type of structure that has the high pressure oil/water mixture on one side at high pressure. The purified water and/or steam is released at a pressure loss of 1 bar or less on the other side of the membrane.

Known perfluorosulfonic acid polymers have chemical stability in temperatures well over 250° C., and are routinely processed at those temperatures in high pressure autoclave reactors to make dispersions. However, there is a need to make the perfluorosulfonic acid polymer stay in place in the membrane, and not leach out into the produced water. There is also a need to develop a type of perfluorosulfonic acid polymer that has the physical stability to remain in place in a supporting structure at temperatures of at least about 180°-225° C. Accordingly, it is an aspect of the disclosure that the perfluorosulfonic acid can be cross-linked or imbibed into a very tight porous matrix such that the perfluorosulfonic acid molecules cannot dissolve away at temperatures of at least about 180°-225° C. A perfluorosulfonic acid silica solgel matrix can also be used to produce better temperature stability.

Although NAFION™ membranes were used commercially as RO membranes in the 1970's, they had disadvantages and were quickly replaced with lower cost ion exchange membranes. Existing NAFION™ membranes unfortunately suffer from low temperature and chemical stability. Existing RO membranes are limited to low temperatures (<80° C.) and only the best ones are able to operate at near 80° C. Moreover, the existing NAFION™ membranes will not work well because their polymers will soften to the point that they will not hold any significant delta pressure at 200° C. All the existing re-enforcements are also too coarse in size. The perfluorosulfonic acid containing membranes disclosed herein provide a unique solution at a now lower relative cost.

It is a further aspect of the disclosure that the membranes can be recycled and the materials recovered to produce additional membranes. A preferred method of recycling is described in U.S. Pat. No. 7,255,798, disclosed herein in its entirety by reference. In the described method, recovering used perfluorosulfonic acid materials includes producing a slurry of water and solvent containing the coated membranes; subjecting the slurry to a pressure of from 500 to 2000 psi at a temperature of from 190° C. to 290° C. in an autoclave for an effective period of time to obtain a pulp material; filtering the pulp material to obtain a filtrate; and centrifuging the filtrate to separate the majority of the perfluorosulfonic acid material from the remainder of the filtrate; and recovering the perfluorosulfonic acid material.

1. A membrane for generating purified steam from waste water, the membrane comprising a perfluorosulfonic acid polymer that has physical stability at about 180°-225° C.

2. The membrane of claim 1 wherein the perfluorsulfonic acid polymer is coated onto a microporous support structure wherein the support structure comprises a carbon black/polytetrafluoroethylene mix.

3. The membrane of claim 1, wherein the perfluorosulfonic acid polymer is coated onto an acid and base stable nanofiltration membrane

4. The membrane of claim 1, wherein the perfluorosulfonic acid is bound to silica or cross-linked to produce a high equivalent weight polymer.

5. A method for transporting purified water through a membrane to generate purified steam from waste water, the method comprising subjecting the waste water to the membrane containing a perfluorosulfonic acid polymer that has physical stability at about 180°-225° C., transporting only the purified water through the membrane, and generating purified steam from the purified water.

6. The method of claim 5 wherein the perfluorosulfonic acid polymer is coated onto a microporous support structure wherein the support structure comprises a carbon black/polytetrafluoro ethylene mix.

7. The method of claim 5, wherein the perfluorosulfonic acid polymer is coated onto an acid and base stable nanofiltration membrane

8. The method of claim 5, wherein the perfluorosulfonic acid is bound to silica or cross-linked to produce a high equivalent weight polymer.

9. A method of treating waste water produced in a finking treatment of an oil or gas well, said method comprising:
recovering contaminated water from a hydraulic fracturing treated oil or gas well at elevated temperature and pressure; and
transporting said contaminated water through a perfluorosulfonic acid coated membrane without prior cooling of the contaminated water, effective to remove oil and mineral contaminants from the contaminated water, producing treated water or steam suitable for use in a subsequent hydraulic fracturing treatment without further purification.

10. The method of claim 9 further comprising the step of transporting said treated water or steam directly to a Once Through Steam Generator system.
